(19) United States
(12) Patent Application Publication
(10) Pub. No.: US 2014/0127375 A1
(43) Pub. Date: May 8, 2014

(54) GEL, A TEMPERATURE-RESISTANT GUMMY CANDY COMPRISING THE SAME, AND A METHOD FOR PREPARING THE GUMMY CANDY

(71) Applicant: NATURAL MEDICINE INSTITUTE OF ZHEJIANG YANGSHENGTANG CO., LTD., Xihu District, Hangzhou, Zheijiang (CN)

(72) Inventors: Cuifeng Cao, Hangzhou (CN); Weiwei Wang, Hangzhou (CN); Huiyan Weng, Hangzhou (CN)

(73) Assignee: NATURAL MEDICINE INSTITUTE OF ZHEJIANG YANGSHENGTANG CO., LTD., Xihu District, Hangzhou, Zheijiang (CN)

(21) Appl. No.: 14/127,308

(22) PCT Filed: Jun. 21, 2012
(86) PCT No.: PCT/CN2012/077347

§ 371 Date: Dec. 18, 2013

(30) Foreign Application Priority Data
Jun. 23, 2011 (CN) 201110170844.7

(51) Int. Cl. A23G 3/42

(52) U.S. Cl. CPC A23G 3/42
USPC 426/548; 426/576

(57) ABSTRACT

The invention relates to a gel, a temperature-resistant candy comprising the same, and a method for preparing the gel gummy candy.

### TECHNICAL FIELD

The invention belongs to the field of food, and relates to a gel, a temperature-resistant candy comprising the same, and a method for preparing the gel gummy candy.

### BACKGROUND ART

Gel gummy candy is a kind of products popular among consumers, and gelatin is used as gelata in most of the products to confer “Q” property on the products. Since gelatin collosol has a gel melting point of about 30° C., gummy candy products with gelatin alone as gelata have a poor temperature resistance, and begin to have the problems of deformation, sticking and melting under a relatively high temperature (36° C.-38° C.), which not only affects the mouthfeel, but also is not suitable for quality guarantee as well as transportation and marketing. In order to meet the market demands of this kind of products in different regions and seasons, it has become an issue of concern in this field as to meet the request of mouthfeel whilst maintaining temperature resistance of the products and extending the shelf life thereof.

### SUMMARY OF THE INVENTION

The inventors found during research that a new mixed gel was obtained by reasonable reconstitution of gelatas and was applied to candies, and the resultant candies comprising the gel has good mastication and mouthfeel as well as excellent temperature resistance and stability. In particular, the candies can be maintained at a temperature of 44° C. for 5 h without causing the problems of affecting qualities, such as sticking, deformation, or melting. The invention was accomplished accordingly.,

In one aspect, the invention relates to a mixed gel, comprising or consisting of gelatin, gellan gum, pectin and modified starch, wherein the proportion of the gelatin, gellan gum, pectin and modified starch (by mass) is: gelatin 4-10 parts, gellan gum 0.1-1 part, pectin 0.2-1.2 parts, modified starch 2-5 parts.

The invention also relates to a gummy candy product, comprising sugar components and a mixed gel, wherein the mixed gel comprises or consists of gelatin, gellan gum, pectin and modified starch, wherein the proportion of gelatin, gellan gum, pectin and modified starch (by mass) is: gelatin 4-10 parts, gellan gum 0.1-1 part, pectin 0.2-1.2 parts, modified starch 2-5 parts.

The invention also relates to a method for preparing a gummy candy product using a mixed gel, wherein the mixed gel comprises or consists of gelatin, gellan gum, pectin and modified starch, wherein the proportion of gelatin, gellan gum, pectin and modified starch (by mass) is: gelatin 4-10 parts, gellan gum 0.1-1 part, pectin 0.2-1.2 parts, modified starch 2-5 parts.

The invention also relates to a method for preparing a gummy candy, comprising the steps of:

1) gel melting: adding water in an amount twice the weight of gelatin to a glue digester, adding gelatin when the temperature is raised to 60° C.-80° C., stirring until the gelatin is completely dissolved, standing at the same temperature for 1-3 h to obtain a transparent gel solution A, and thoroughly mixing gellan gum and pectin with white granulated sugar or solid sugar alcohol in an amount 5 times the weight thereof, and adding water in an amount 12 times the weight thereof and boiling the mixture to obtain a gel solution B,

2) sugar melting: after boiling the sugar components by heating, adding water-dispersed modified starch paste in an amount twice the weight thereof, keeping the sugar solution boiling and adding the gel solution B, continuing boiling until the solids in the sugar solution reach 76-80 Brix as measured by Brix spindke, and then stopping heating to obtain the substance C,

3) sugaring off: mixing the transparent gel solution A and the substance C, stirring the mixture homogeneously, and then performing vacuum degassing until the solution is transparent and contains no bubble, to obtain a mixed solution with a temperature of 80° C.-95° C.,

4) blending: pouring the mixed solution obtained in step 3) into a blending barrel, the temperature of which is set to 80° C.-90° C., and then adding sour agent, edible essence, edible colorant to the mixed solution, and homogenously stirring and blending the mixture,

5) casting moulding: performing casting by transferring the blended solution in step 4) to a casting machine,

6) drying: transferring the gummy candy product obtained after casting moulding in step 5) to a confined space at 20° C.-30° C. and a relative humidity of 15%-40%, and drying the product to a water content of 12%-20%;

7) subjecting the dried product to demoulding, polishing and packaging to obtain the final product.

According to the invention, the term “sugar component” as described in the invention refers to sugar in a broad sense, which for example, includes, but is not limited to sugar with a sweet taste, such as while granulated sugar, starch syrup, sugar without a sweet taste or suitable for patients with diabetes, such as xylitol.

According to the invention, the “%” as described in the invention generally refers to “% by mass”, unless otherwise specified.

According to the invention, the proportion of the components of the mixed gel (by mass) is generally: gelatin 4-10 parts, gellan gum 0.1-1 part, pectin 0.2-1.2 parts, modified starch 2-5 parts; preferably gelatin 4-9 parts, gellan gum 0.1-0.8 part, pectin 0.2-1.2 parts, modified starch 2-5 parts; more preferably: gelatin 5-8 parts, gellan gum 0.1-0.8 part, pectin 0.2-0.8 part, modified starch 2-5 parts; even more preferably, gelatin 5-7 parts, gellan gum 0.1-0.6 part, pectin 0.2-0.6 part, modified starch 2-4 parts.

According to the invention, the raw materials used in the invention include, but are not limited to those wherein the gelatin is hide glue or bone glue with a gel strength of above 180 Bloom, the starch syrup has a DE value of 38%-44% and a solid content of 70%-84%, the sorbitol solid content is 70%, the modified starch is the acetate starch of potato, corn, cassava, the sour agent is selected from the group consisting of one or more of citric acid, malic acid, lactic acid, tartaric acid or phosphoric acid; the edible essence and the edible colorant are one or more of additives that are allowed to be added to gel candies according to regulations on food additives.

According to the invention, the temperature-resistant gel gummy candy of the invention consists of the following components in the following proportion:

| | |
|---|---|
| white granulated sugar | 10%-50% |
| starch syrup | 10%-50% |
| gelatin | 4%-10% |
| sorbitol | 2%-6% |
| gellan gum | 0.1%-1% |
| modified starch | 2%-5% |
| pectin | 0.2%-1.2% |
| sour agent | 0.5%-5% |
| edible essence | 0.1%-2% |
| edible colorant | 0.005%-0.05% |
| water | 12%-20%; |

preferably comprises the following components in the following proportion:

| | |
|---|---|
| white granulated sugar | 15%-40% |
| starch syrup | 10%-40% |
| gelatin | 4%-9% |
| sorbitol | 2%-5% |
| gellan gum | 0.1%-0.8% |
| modified starch | 2%-5% |
| pectin | 0.2%-1.2% |
| sour agent | 0.5%-5% |
| edible essence | 0.1%-2% |
| edible colorant | 0.005%-0.05% |
| water | 12%-20%. |

More preferably, the temperature-resistant gel candy comprises the following components in the following proportion:

| | |
|---|---|
| white granulated sugar | 20%-35% |
| starch syrup | 15%-40% |
| gelatin | 5%-8% |
| sorbitol | 2%-5% |
| gellan gum | 0.1%-0.8% |
| modified starch | 2%-5% |
| pectin | 0.2%-0.8% |
| sour agent | 0.5%-4% |
| edible essence | 0.1%-1.5% |
| edible colorant | 0.005%-0.04% |
| water | 12%-20%. |

Even more preferably, the temperature-resistant gel candy comprises the following components in the following proportion:

| | |
|---|---|
| white granulated sugar | 25%-35% |
| starch syrup | 18%-35% |
| gelatin | 5%-7% |
| sorbitol | 2%-4% |
| gellan gum | 0.1%-0.6% |
| modified starch | 2%-4% |
| pectin | 0.2%-0.6% |
| sour agent | 0.5%-4% |
| edible essence | 0.1%-1.5% |
| edible colorant | 0.005%-0.04% |
| water | 12%-20%. |

According to the invention, the gelatin is hide glue or bone glue with a gel strength of above 180 Bloom,

the starch syrup has a DE value of 38%-44% and a solid content of 70%-84%,

the sorbitol solid content is 70%,

the modified starch is the acetate starch of potato, corn, cassava,

the sour agent is selected from the group consisting of one or more of citric acid, malic acid, lactic acid, tartaric acid or phosphoric acid;

the edible essence and the natural edible colorant are one or more of additives that are allowed to be added to gel candies according to regulations on food additives.

### Advantageous Effects of the Invention

Since the gelata of the invention is resulted from reasonable reconstitution of gelatin, gellan gum, pectin and modified starch, the resistant temperature of the products of the invention is 5° C.-8° C. higher than that of products using gelatin gel alone, and the products of the invention have good stability and solve the problems of melting, sticking and deformation that are liable to occur under high-temperature environment in summer. The transportation and sale of the products of the invention are easier. Hence, the invention is of great significance in the technical field of gel candies.

### SPECIFIC MODE FOR CARRYING OUT THE INVENTION

The embodiments of the invention are described in detail by combining the following Examples. However, a person skilled in the art would understand that the following Examples are intended to illustrate the invention, rather than limiting the scope of the invention. Under the circumstance where the specific conditions are not indicated in the Examples, the embodiments are carried out according to conventional conditions or according to the conditions proposed by the manufacturer. The reagents or equipments, the manufacturers of which are not indicated, are routine products that are commercially available.

### Example 1:

Materials: white granulated sugar 5.5 kg, 84% starch syrup 9.0 kg, sorbitol 1.2 kg, potato modified starch 1.6 kg, gelatin 4.0 kg, pectin 0.2 kg, gellan gum 0.06 kg, anhydrous citric acid 0.52 kg, blueberry essence 0.1 kg, grape skin red 0.008 kg.

The temperature-resistant gel gummy candy was prepared according to the following steps :

1) gel melting: adding water in an amount twice the weight of gelatin to a glue digester, adding gelatin when the temperature is raised to 60° C.-80° C., stirring until the gelatin was completely dissolved, standing at the same temperature for 2 h to obtain a transparent gel solution A, thoroughly mixing gellan gum and pectin with white granulated sugar in an amount 5 times the weight thereof, adding water in an amount 10 times the weight thereof, and boiling the mixture to obtain a gel solution B,

2) sugar melting: after boiling white granulated sugar, starch syrup, and sorbitol by heating, adding water-dispersed modified starch paste in an amount twice the weight thereof, keeping the sugar solution boiling and adding the gel solution B, continuing boiling until the solids in the sugar solution reached 76-80 Brix as measured by Brix spindke, and then stopping heating to obtain the substance C,

3) sugaring off: mixing the transparent gel solution A and the substance C, stirring the mixture homogenously, and then performing vacuum degassing until the solution was transparent and contained no bubble, to obtain a mixed solution with a temperature of 80° C.-95° C.,

4) blending: pouring the mixed solution obtained in step 3) into a blending barrel, the temperature of which was set to 80° C.-90° C., and then adding 50% citric acid solution, blueberry essence, grape skin red to the mixed solution, and homogenously stirring and blending the mixture;

5) casting moulding: performing casting by transferring the blended solution in step 4) to a casting machine, selecting a casting mould in a bear shape (3.0 g/grain), and getting about 7000 grains;

6) drying: transferring the gummy candy product obtained after casting moulding in step 5) to a confined space at about 25° C. and a relative humidity of 25%-35%, and drying the product to a water content of 18%;

7) subjecting the dried product to demoulding, polishing and packaging to obtain the final product.

### Example 2

Materials: white granulated sugar 6 kg, 76% starch syrup 11 kg, sorbitol 1 kg, potato modified starch 1.2 kg, gelatin 4.4 kg, pectin 0.2 kg, gellan gum 0.05 kg, buffered lactic acid 1 kg, strawberry essence 0.12 kg, cochineal solution 0.006 kg.

The temperature-resistant gel gummy candy was prepared according to the following steps:

1) gel melting: adding water in an amount twice the weight of gelatin to a glue digester, adding gelatin when the temperature was raised to 60° C.-80° C., stirring until gelatin was completely dissolved, standing at the same temperature for 2 h to obtain a transparent gel solution A, thoroughly mixing gellan gum and pectin with white granulated sugar in an amount 5 times the weight thereof, adding water in an amount 10 times the weight thereof and boiling the mixture to obtain a gel solution B;

2) sugar melting: after boiling white granulated sugar, starch syrup, and sorbitol by heating, adding water-dispersed modified starch paste in an amount twice the weight thereof, keeping the sugar solution boiling and adding the gel solution B, continuing boiling until the solids in the sugar solution reached 80-82 Brix as measured by Brix spindke, and then stopping heating to obtain the substance C;

3) sugaring off: mixing the transparent gel solution A and the substance C, stirring the mixture homogenously, and then performing vacuum degassing until the solution was transparent and contained no bubble, to obtain a mixed solution with a temperature of 80° C.-95° C.,

4) blending: pouring the mixed solution obtained in step 3) into a blending barrel, the temperature of which was set to 80° C.-90° C., and then adding buffered lactic acid, strawberry essence, and cochineal colorant to the mixed solution, and homogenously stirring and blending the mixture,

5) casting moulding: performing casting by transferring the blended solution in step 4) to a casting machine, selecting a casting mould in a strawberry shape (2.5 g/grain), and getting about 9000 grains;

6) drying: transferring the gummy candy product obtained after casting moulding in step 5) to a confined space at about 28° C. and a relative humidity of 30%-35%, and drying the product to a water content of 16%;

7) subjecting the dried product to demoulding, polishing and packaging to obtain the final product.

### Example 3

Materials: white granulated sugar 6 kg, 80% starch syrup 8.8 kg, sorbitol 1.6 kg, corn modified starch 1 kg, gelatin 4.6 kg, pectin 0.4 kg, gellan gum 0.04 kg, anhydrous citric acid 0.8 kg, malic acid 0.3 kg, lemon essence 0.04 kg, lutein 0.001 kg.

The temperature-resistant gel gummy candy was prepared according to the following steps:

1) gel melting: adding water in an amount twice the weight of gelatin to a glue digester, adding gelatin when the temperature was raised to 60° C.-80° C., stirring until gelatin was completely dissolved, standing at the same temperature for 2 h to obtain a transparent gel solution A, thoroughly mixing gellan gum and pectin with white granulated sugar in an amount 5 times the weight thereof, adding water in an amount 10 times the weight thereof, and boiling the mixture to obtain a gel solution B,

2) sugar melting: after boiling white granulated sugar, starch syrup, and sorbitol by heating, adding water-dispersed modified starch paste in an amount twice the weight thereof, keeping the sugar solution boiling and adding the gel solution B, continuing boiling until the solids in the sugar solution reached 80 Brix as measured by Brix spindke, and then stopping heating to obtain the substance C,

3) sugaring off: mixing the transparent gel solution A and the substance C, stirring the mixture homogenously, and then performing vacuum degassing until the solution was transparent and contained no bubble, to obtain a mixed solution with a temperature of 80° C.-95° C.,

4) blending: pouring the mixed solution obtained in step 3) into a blending barrel, the temperature of which was set to 80° C.-90° C., and then adding 50% citric acid and malic acid solution, lemon essence, lutein to the mixed solution, and homogenously stirring and blending the mixture,

5) casting moulding: performing casting by transferring the blended solution in step 4) to a casting machine, selecting a casting mould in a semicircle shape (4.0 g/grain), and getting about 5000 grains;

6) drying: transferring the gummy candy product obtained after casting moulding in step 5) to a confined space at about 22° C. and a relative humidity of 28%-30%, and drying the product to a water content of 20%;

7) subjecting the dried product to demoulding, polishing and packaging to obtain the final product.

### Example 4

### Sugar-Free Temperature-Resistant Gel Gummy Candy 1

Materials: isomaltitol 6 kg, 75% maltitol solution 32.8 kg, corn modified starch 1.6 kg, gelatin 2.6 kg, pectin 0.4 kg, gellan gum 0.06 kg, anhydrous citric acid 0.8 kg, malic acid 0.3 kg, mango essence 0.04 kg, lutein 0.001 kg.

The temperature-resistant gel gummy candy was prepared according to the following steps:

1) gel melting: adding water in an amount twice the weight of gelatin to a glue digester, adding gelatin when the temperature was raised to 60° C.-80° C., stirring until gelatin was completely dissolved, standing at the same temperature for 2 h to obtain a transparent gel solution A, and thoroughly mixing gellan gum and pectin with isomaltitol in an amount 5 times the weight thereof, and adding water in an amount 10 times the weight thereof and boiling the mixture to obtain a gel solution B,

2) sugar melting: after boiling isomaltitol and maltitol solution by heating, adding water-dispersed modified starch paste in an amount twice the weight thereof, keeping the sugar solution boiling and adding the gel solution B, continuing boiling until the solids in the sugar solution reached 80 Brix as measured by Brix spindke, and then stopping heating to obtain the substance C,

3) sugaring off: mixing the transparent gel solution A and the substance C, stirring the mixture homogenously, and then performing vacuum degassing until the solution was transparent and contained no bubble, to obtain a mixed solution with a temperature of 80° C.-95° C.,

4) blending: pouring the mixed solution obtained in step 3) into a blending barrel, the temperature of which was set to 80° C.-90° C., and then adding 50% citric acid solution and malic acid solution, mango essence, lutein to the mixed solution, and homogenously stirring and blending the mixture,

5) casting moulding: performing casting by transferring the blended solution in step 4) to a casting machine, selecting a casting mould in a bear shape (3.0 g/grain), and getting about 12000 grains;

6) drying: transferring the gummy candy product obtained after casting moulding in step 5) to a confined space at about 24° C. and a relative humidity of 25%-28%, and drying the product to a water content of 18%;

7) subjecting the dried product to demoulding, polishing and packaging to obtain the final product.

### Example 5

### Sugar-Free Temperature-Resistant Gel Gummy Candy 2

The materials included: xylitol 41 kg, 75% maltol solution 12.8kg, sorbitol 0.9 kg, corn modified starch 0.5 kg, gelatin 1.6 kg, pectin 0.2 kg, gellan gum 0.02 kg, anhydrous citric acid 0.4 kg, malic acid 0.2 kg, cherry essence 0.02 kg.

The temperature-resistant gel gummy candy was prepared according to the following steps:

1) gel melting: adding water in an amount twice the weight of gelatin to a glue digester, adding gelatin when the temperature was raised to 60° C.-80° C., stirring until gelatin was completely dissolved, standing at the same temperature for 2 h to obtain a transparent gel solution A, and thoroughly mixing gellan gum and pectin with xylitol in an amount 5 times the weight thereof, and adding water in an amount 10 times the weight thereof and boiling the mixture to obtain a gel solution B,

2) sugar melting: after boiling xylitol, maltol, and sorbitol by heating, adding water-dispersed modified starch paste in an amount twice the weight thereof, keeping the sugar solution boiling and adding the gel solution B, continuing boiling until the solids in the sugar solution reached 82 Brix as measured by Brix spindke, and then stopping heating to obtain the substance C,

3) sugaring off: mixing the transparent gel solution A and the substance C, stirring the mixture homogenously, and then performing vacuum degassing until the solution was transparent and contained no bubble, to obtain a mixed solution with a temperature of 80° C.-95° C.,

4) blending: pouring the mixed solution obtained in step 3) into a blending barrel, the temperature of which was set to 80° C.-90° C., and then adding 50% citric acid and malic acid solution, and cherry essence, to the mixed solution, and homogenously stirring and blending the mixture,

5) casting moulding: performing casting by transferring the blended solution in step 4) to a casting machine, selecting a casting mould in a bear shape (3.0 g/grain), and getting about 6000 grains;

6) drying: transferring the gummy candy product obtained after casting moulding in step 5) to a confined space at about 22° C. and a relative humidity of 18%-20%, and drying the product to a water content of 17%; and

7) subjecting the dried product to demoulding, polishing and packaging to obtain the final product.

### Example 6

### Organoleptic Investigation Assay on Temperature-Resistant Gel Gummy Candy

The gel gummy candies obtained above were subjected to organoleptic investigation assay. In the organoleptic investigation assay, 20 valuators were invited to degust and assess various samples, and evaluated the three items, i.e. taste, mouthfeel (Q property or chewing feel) and total eating feel by the scoring method in accordance with evaluation standards in Table 1.

TABLE 1
The organoleptic investigation standards for
temperature-resistant gel gummy candy (5 grades)

| Evaluation Items | Evaluation standards | Scores |
|---|---|---|
| Gel gummy candy | Bad (tough, sticky or no Q | 1 |
| taste | property) | |
| mouth feel | poor | 2 |
| total eating feel | ordinary | 3 |
| | good | 4 |
| | very good (neither too hard, nor | 5 |
| | too soft) | |

The results of organoleptic investigation assay were represented by the average values of evaluation of various samples made by 20 assessors, as listed in Table 2, wherein Comparative samples 1, 2 and Comparative sample 3 were commercially available gel gummy candies of the same gelatin type (3 g/grain). For Comparative sample 1, it was shown on the label that the ingredients include glucose syrup, white granulated sugar, gelatin, citric acid, edible essence, and carminum. For Comparative sample 2, it was shown on the label that the ingredients include glucose syrup, white granulated sugar, gelatin, pectin, citric acid, edible essence, and allura red. For Comparative sample 3, it was shown on the label that the ingredients include maltitol, erythritol, xylitol, gelatin, sucralose, citric acid, malic acid, and edible essence.

TABLE 2
Results of organoleptic investigation assay on gel gummy candy

| | Organoleptic investigation items | | |
|---|---|---|---|
| | Taste of gummy | Mouthfeel of | Total eating |
| Samples | candy | gummy candy | feel |
| Comparative | 3.8 | 3.2 | 3.2 |
| sample 1 | | | |
| Comparative | 4.0 | 3.6 | 3.8 |
| sample 2 | | | |
| Comparative | 4.1 | 3.8 | 4.0 |
| sample 3 | | | |
| Example 1 | 4.6 | 4.3 | 4.6 |
| Example 2 | 4.3 | 4.4 | 4.4 |
| Example 3 | 4.5 | 4.7 | 4.5 |
| Example 4 | 4.2 | 4.3 | 4.3 |
| Example 5 | 4.6 | 4.5 | 4.5 |

The Comparative samples 1-3 in the prior art are common commercially available gelatin gel gummy candies (wherein Comparative sample 3 is sugar-free gelatin gel candy), which were evaluated to have a good taste and a general mouthfeel score. The samples prepared in Examples 1-5 had good results in the evaluation of the three items.

### Example 7

### Stability Investigation 1 of the Temperature-Resistant Gel Gummy Candies (Temperature Resistance Assay)

The temperature-resistant gel gummy candy samples 1-5, and Comparative samples 1-3 were respectively packaged in the same weight (180 g, i.e. 60 grains for the sample 3 g/grain, 45 grains for the sample 4 g/grain, 72 grains for the sample 2.5 g/grain) in identical containers which were placed in a thermostat (the temperature was set in the range of 38-44° C., and the samples were placed at each temperature for 12 h, and the temperature was increased by 2° C. for each time). By comparing deformation, surface sticking and melting, the highest resistant temperature and duration of the products were determined, wherein when there was no sticking and no deformation among products, the products were evaluated as “V”; when there was sticking and slight deformation among products but the products were easily separated, the products were evaluated as “O”; and when there was sticking and melting phenomenon among products and the products were not easily separated, the products were evaluated as “X”.

The temperature resistance results of the products evaluated by temperature resistance assay are shown in Table 3.

TABLE 3
Results of temperature-resistance assay

Results of
temperature-resistance assay

| Samples | 38° C. | 40° C. | 42° C. | 44° C. |
|---|---|---|---|---|
| Comparative | V | O | X | |
| sample 1 | | | | |
| Comparative | O | X | X | |
| sample 2 | | | | |
| Comparative | V | V | O | X |
| sample 3 | | | | |
| Example 1 | V | V | V | O |
| Example 2 | V | V | V | O |
| Example 3 | V | V | V | V |
| Example 4 | V | V | V | V |
| Example 5 | V | V | V | V |

The results of table 3 show that the temperature-resistant gel gummy candies of the invention are clearly superior to commercially available gelatin gel gummy candy products in terms of temperature resistance.

### Example 8

### Stability Investigation 2 of the Temperature-Resistant Gel Gummy Candies (Shelf Life Assay)

The gel gummy candy samples 1-5 and Comparative samples 1-3 were respectively packaged in the same weight (180 g, i.e. 60 grains for the sample 3 g/grain, 45 grains for the sample 4 g/grain, 72 grains for the sample 2.5 g/grain) in identical containers which were placed in a 37-38° C./RH75% constant temperature and constant humidity chamber. After measuring the initial value at 0 day, organoleptic, physiochemical, and microbial indexes were measured every 15 days. If all the indexes met the labeled values and the product standards, the products were investigated continuously so as to determine the shelf life of the products. Generally, those, all the measured values of which met the requirements at day 45, had a shelf life of at least 12 months, and those, all the measured values of which met the requirements at day 90, had a shelf life of at least 24 months. The samples, one of whose organoleptic, physiochemical, and microbial indexes, did not meet the requirements were marked as “−”. The samples, two of whose organoleptic, physiochemical, and microbial indexes did not meet the requirements, were marked as “--”. And the samples, all of whose indexes met the requirements, were marked as “+”. The results were shown in table 4.

TABLE 4
Results of shelf life assay

| | Results of shelf life assay | | | | | |
|---|---|---|---|---|---|---|
| Samples | 15 d | 30 d | 45 d | 60 d | 75 d | 90 d |
| Comparative | + | + | − | −− | | |
| sample 1 | | | | | | |
| Comparative | + | + | − | −− | | |
| sample 2 | | | | | | |
| Comparative | + | + | + | − | −− | |
| sample 3 | | | | | | |
| Example 1 | + | + | + | + | + | − |
| Example 2 | + | + | + | + | + | + |
| Example 3 | + | + | + | + | + | + |
| Example 4 | + | + | + | + | + | + |
| Example 5 | + | + | + | + | + | + |

The results in table 4 show that the temperature-resistant gel gummy candy samples of the invention have a much longer shelf life than the Comparative samples, which is good for storage and sales of products.

In sum, the temperature-resistant gel gummy candies of the invention have good taste and mouthfeel, good temperature resistance, as well as a long shelf life.

Although the specific embodiments of the invention have been described in detail, a person skilled in the art would understand that according to all the teachings disclosed herein, various modifications and substitutions may be made to the details, and these changes fall into the protection scope of the invention. The whole scope of the invention is defined by the appended claims and any other equivalent thereof.

1. A mixed gel comprising or consisting of gelatin, gellan gum, pectin and modified starch, wherein the proportion of gelatin, gellan gum, pectin and modified starch (by mass) is: gelatin 4-10 part, gellan gum 0.1-1 part, pectin 0.2-1.2 parts, modified starch 2-5 parts.

2. The mixed gel according to claim 1, wherein the proportion of gelatin, gellan gum, pectin and modified starch (by mass) is: gelatin 4-10 parts, gellan gum 0.1-1 part, pectin 0.2-1.2 parts, modified starch 2-5 parts; preferably gelatin 4-9 parts, gellan gum 0.1-0.8 part, pectin 0.2-1.2 parts, modified starch 2-5 parts; more preferably, gelatin 5-8 parts, gellan gum 0.1-0.8 part, pectin 0.2-0.8 part, modified starch 2-5 parts; even more preferably, gelatin 5-7 parts, gellan gum 0.1-0.6 part, pectin 0.2-0.6 part, and modified. starch 2-4 parts.

3. A gummy candy product comprising sugar components and a mixed gel, wherein the mixed gel comprises or consists of gelatin, gellan gum, pectin and modified starch, wherein the proportion of gelatin, gellan gum, pectin and modified starch (by mass) is: gelatin 4-10 parts, gellan gum 0.1-1 part, pectin 0.2-1.2 parts, modified starch 2-5 parts.

4. The gummy candy product according to claim 3, characterized in that it comprises the following components in the following proportion:

| | |
|---|---|
| white granulated sugar | 10%-50% |
| starch syrup | 10%-50% |
| gelatin | 4%-10% |
| sorbitol | 2%-6% |
| gellan gum | 0.1%-1% |
| modified starch | 2%-5% |
| pectin | 0.2%-1.2% |
| sour agent | 0.5%-5% |
| edible essence | 0.1%-2% |
| edible colorant | 0.005%-0.05% |
| water | 12%-20%. |

5. The gummy candy product according to claim 3, comprising the following components in the following proportion:

| | |
|---|---|
| white granulated sugar | 15%-40% |
| starch syrup | 10%-40% |
| gelatin | 4%-9% |
| sorbitol | 2%-5% |
| gellan gum | 0.1%-0.8% |
| modified starch | 2%-5% |
| pectin | 0.2%-1.2% |
| sour agent | 0.5%-5% |
| edible essence | 0.1%-2% |
| edible colorant | 0.005%-0.05% |
| water | 12%-20%. |

6. The gummy candy product according to claim 3, wherein the temperature-resistant gel candy comprises:

| | |
|---|---|
| white granulated sugar | 20%-35% |
| starch syrup | 15%-40% |
| gelatin | 5%-8% |
| sorbitol | 2%-5% |
| gellan gum | 0.1%-0.8% |
| modified starch | 2%-5% |
| pectin | 0.2%-0.8% |
| sour agent | 0.5%-4% |
| edible essence | 0.1%-1.5% |
| edible colorant | 0.005%-0.04% |
| water | 12%-20%. |

7. The gummy candy product according to claim 3, wherein the temperature-resistant gel candy comprises:

| | |
|---|---|
| white granulated sugar | 25%-35% |
| starch syrup | 18%-35% |
| gelatin | 5%-7% |
| sorbitol | 2%-4% |
| gellan gum | 0.1%-0.6% |
| modified starch | 2%-4% |
| pectin | 0.2%-0.6% |
| sour agent | 0.5%-4% |
| edible essence | 0.1%-1.5% |
| edible colorant | 0.005%-0.04% |
| water | 12%-20%. |

8. The gummy candy product according to claim 3, wherein:
the gelatin is hide glue or bone glue with a gel strength of above 180 Bloom;
the starch syrup has a DE value of 38%-44% and a solid content of 70%-84%;
the sorbitol solid content is 70%;
the modified starch is the acetate starch of potato, corn, or cassava;
the sour agent is selected from the group consisting of one or more of citric acid, malic acid, lactic acid, tartaric acid or phosphoric acid; and
the edible essence and the natural edible colorant are one or more additives that are allowed to be added to gel candies according to regulations on food additives.

9. A method for preparing the gummy candy product according to claim 3, comprising:
1) gel melting: adding water in an amount twice the weight of gelatin to a glue digester, adding gelatin when the temperature is raised to 60° C.-80° C., stirring until gelatin is completely dissolved, standing at the same temperature for 1-3 h to obtain a transparent gel solution A, thoroughly mixing gellan gum and pectin with white granulated sugar or sugar alcohol in an amount 5 times the weight thereof, and adding water in an amount 12 times the weight thereof, and boiling the mixture to obtain a gel solution B,
2) sugar melting: after boiling white granulated sugar, starch syrup, or sugar alcohols, sweetener by heating, adding water-dispersed modified starch paste in an amount twice the weight thereof, keeping the sugar solution boiling and adding the gel solution B, continuing boiling until the solids in the sugar solution reach 76-80 Brix as measured by Brix spindke, and then stopping heating to obtain the substance C,
3) sugaring off: mixing the transparent gel solution A and the substance C, stirring the mixture homogenously, and then performing vacuum degassing until the solution is transparent and contains no bubble, to obtain a mixed solution with a temperature of 80° C.-95° C.,
4) blending: pouring the mixed solution obtained in step 3) into a blending barrel, the temperature of which is set, to 80° C.-90° C., and then adding sour agent, edible essence, edible colorant to the mixed solution, and homogenously stirring and blending the mixture,
5) casting moulding: performing casting by transferring the blended solution in step 4) to a casting machine,
6) drying: transferring the gummy candy product obtained after casting moulding in step 5) to a confined space at 20° C.-30° C. and a relative humidity of 15%-40%, and drying the product to a water content of 12%-20%;
7) subjecting the dried product to demoulding, polishing and packaging to obtain the final product.

10. A method for preparing a gummy candy product using a mixed gel, wherein the mixed gel comprises or consists of gelatin, gellan gum, pectin and modified starch, wherein the proportion of gelatin, gellan gum, pectin and modified starch (by mass) is: gelatin 4-10 parts, gellan gum 0.1-1 part, pectin 0.2-1.2 parts, modified starch 2-5 parts.
